(19) United States
(12) Patent Application Publication
(10) Pub. No.: US 2022/0335452 A1
(43) Pub. Date: Oct. 20, 2022

(54) SYSTEMS AND METHODS FOR RETAIL FACILITIES

(71) Applicant: Walmart Apollo, LLC, Bentonville, AR (US)

(72) Inventors: Ramandeep Singh, Bengaluru (IN); Venkata Janendra Pachigolla, Bangalore (IN); Deepak Mandya Chandranath, Bangalore (IN); Chandresh Bhardwaj, Bangalore (IN)

(21) Appl. No.: 17/725,347

(22) Filed: Apr. 20, 2022

Related U.S. Application Data
(60) Provisional application No. 63/176,990, filed on Apr. 20, 2021.

(51) Int. Cl. G06Q 30/02; G06T 19/00; G06V 20/50; G06T 7/10

(52) U.S. Cl. CPC G06Q 30/0201; G06T 19/006; G06V 20/50; G06T 7/10

(57) ABSTRACT

In some embodiments, apparatuses and methods are provided herein useful to augmented reality presentations. In some embodiments, an augmented reality system comprises a database configured to store metrics associated with departments of a retail facility, an application configured to be executed on a mobile device, wherein execution of the application causes the mobile device to capture an image, receive a user selection including an indication of a location on the image, and transmit the image and an indication of the location, a control circuit configured to receive the image and the indication of the location, identify the one of the plurality of objects, retrieve metrics for the department, transmit the metrics for the department, wherein execution of the application on the mobile device further causes the mobile device to receive the metrics for the department, generate an augmented reality presentation, and present the augmented reality presentation.

### RELATED APPLICATIONS

This application claims the benefit of U.S. Provisional Application No. 63/176,990, filed Apr. 20, 2021, which is incorporated herein by reference in its entirety.

### TECHNICAL FIELD

This invention relates generally to retail facilities and, more specifically, augmented reality systems for retail facilities.

### BACKGROUND

Most retailers strive to provide customers with positive experiences when shopping in retail facilities and purchasing products online. One way that retailers can provide such experiences is by understanding customer needs and preferences. In an effort to understand customer needs and preferences, many retailers analyze data gathered about the retail facility and shopping habits of the customers. While all of this data can be useful, it is often difficult to not only analyze the data but also to present the data in a user-friendly manner. Accordingly, a need exists for better data analysis and data presentation.

### BRIEF DESCRIPTION OF THE DRAWINGS

Disclosed herein are embodiments of systems, apparatuses, and methods pertaining to augmented reality systems for use in a retail facility. This description includes drawings, wherein:

FIGS. 1A and 1B depict a mobile device 104 presenting an augmented reality presentation 106, according to some embodiments;

FIG. 2 is a block diagram of a system 200 for augmented reality presentations, according to some embodiments;

FIG. 3 is a flow chart depicting example operations for presenting an augmented reality presentation; and

FIG. 4 is a block diagram of a mobile device 400, according to some embodiments.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

Generally speaking, pursuant to various embodiments, systems, apparatuses and methods are provided herein useful to augmented reality presentations. In some embodiments, an augmented reality system for use in a retail facility comprises a database, wherein the database is configured to store metrics associated with departments of the retail facility, an application configured to be executed on a mobile device, wherein execution of the application on the mobile device causes the mobile device to capture, via an image capture device, an image, wherein the image includes a portion of the retail facility and a plurality of objects, receive, via a user input device, a user selection, wherein the user selection is associated with a location on the image, and wherein the user selection selects one of the plurality of objects from the image, and transmit, via a communications network to a control circuit, the image and an indication of the location on the image, the control circuit, wherein the control circuit is communicatively coupled to the mobile device, and wherein the control circuit is configured to receive, from the mobile device, the image and the indication of the location on the image, identify, based on the image and the indication of the location on the image, the one of the plurality of objects, wherein the one of the plurality of objects is associated with a department of the retail facility, retrieve, from the database, metrics for the department of the retail facility, transmit, to the mobile device, the metrics for the department of the retail facility, wherein execution of the application on the mobile device further causes the mobile device to receive, from the control circuit, the metrics for the department of the retail facility, generate, based on the image and the metrics for the department of the retail facility, an augmented reality presentation, wherein the augmented reality presentation includes the image and a presentation of the metrics for the department of the retail facility, and present, via a display device, the augmented reality presentation.

As previously discussed, retailers strive to provide positive experiences to customers shopping in-store and online. Often, retailers gather data regarding retail facilities and shopping habits of the customers in an effort to provide positive experiences. Unfortunately, such data gathering typically results in a significant amount of information that is difficult to analyze and present. Without proper analysis and presentation, the data gathered is of little use to retailers.

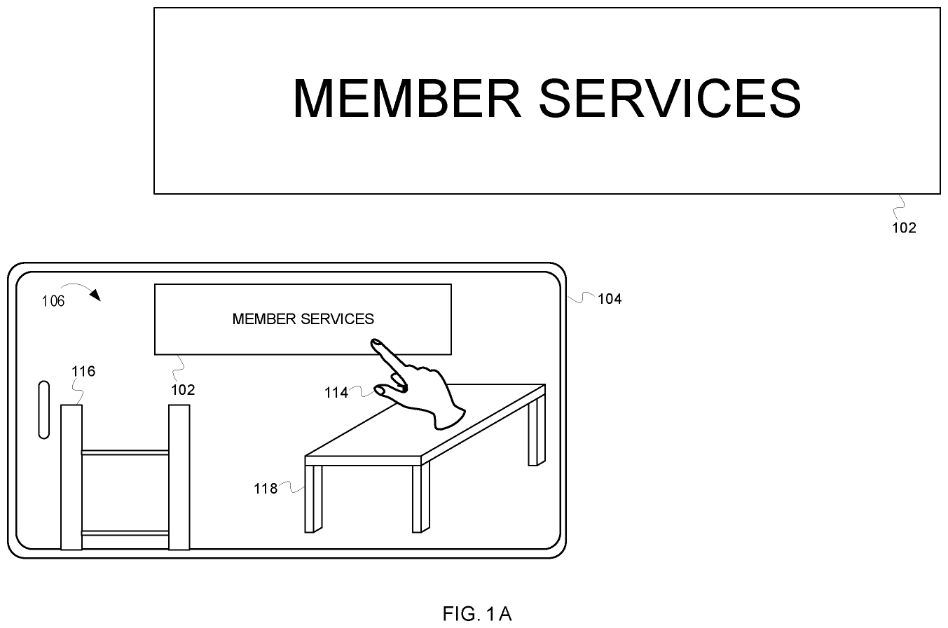

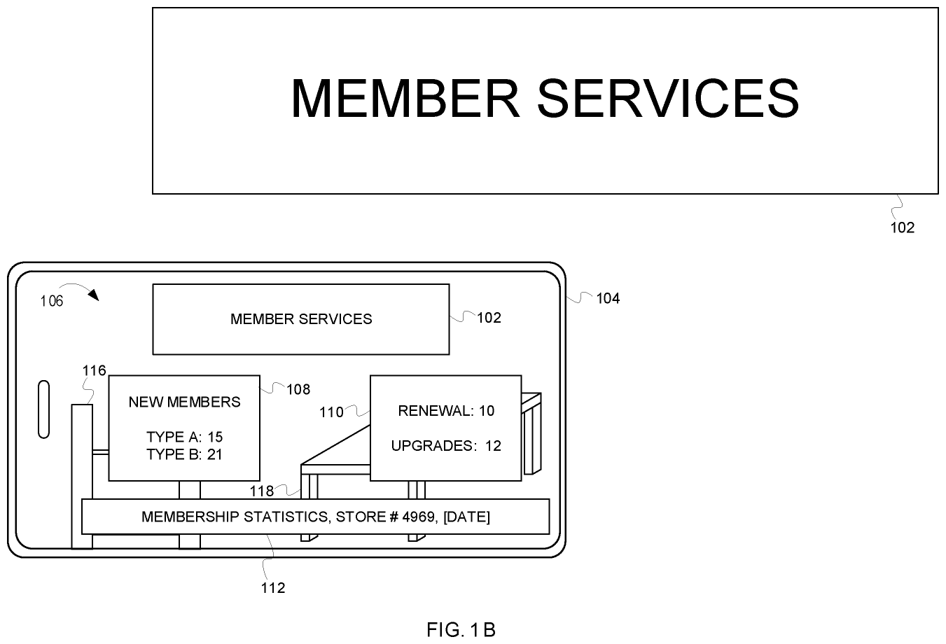

Described herein are systems, methods, and apparatuses that seek to provide a presentation of data gathered in a user-friendly manner. For example, in one embodiment, the data is presented via an augmented reality presentation. The augmented reality presentation includes information about the retail facility. In one embodiment, the information about the retail facility includes metrics for a department of the retail facility. For example, if the department is the bakery department, the augmented reality presentation can include metrics for the bakery department including the types of products available, temporal information related to when the products were baked, shelf life for products, temporal information about when new and/or additional products will be ready, purchasing trends for the bakery department, etc. The discussion of FIGS. 1A and 1B provides an overview of such an augmented reality presentation.

FIGS. 1A and 1B depict a mobile device 104 presenting an augmented reality presentation 106, according to some embodiments. In one embodiment, a user (e.g., an employee of a retail facility) uses the mobile device 104 to view information about the retail facility via the augmented reality presentation 106. As one example, the user can view metrics associated with departments of the retail facility. The user captures images of the retail facility via the mobile device 104 (e.g., images from within the retail facility, outside the retail facility, of a stockroom, of a salesfloor, etc.). The images of the retail facility include objects, such as a sign 102 or other features, shelving units 116, counters, walls, products, displays, tables 118, and so on. The objects are associated with departments of the retail facility, such as a member services department, a pharmacy department, a point-of-sale (POS) department, an optical department, a grocery department, a sporting goods department, an electronics department, an automotive department, a fueling department, a photo department, a bakery department, etc. The user can select the objects to view information, such as metrics, associated with the objects. The metrics can include, for example, memberships sold, memberships renewed, trends, memberships expiring soon, types of memberships purchased, a number of memberships upgraded, membership conversion rates, total sales (e.g., for a department), sales metrics, retail facility sales data, etc. As depicted in FIGS. 1A and 1B, the sign 102 is associated with a member services department.

The augmented reality presentation 106 includes one of the images and information about the retail facility. Continuing the example depicted in FIGS. 1A and 1B, the user has selected to view information about the member services department. That is, as depicted in FIG. 1A, the user has selected the sign 102 from the augmented reality presentation 106, as indicated by a hand 114. Selection of the sign 102 causes the augmented reality presentation 106 to present information associated with the sign 102.

As depicted in FIG. 1B, the augmented reality presentation 106 includes metrics for the member services department based on the selection of the sign 102 in FIG. 1A. In the example depicted in FIG. 1B, the metrics include data regarding new members 108 (e.g., new memberships sold), existing memberships 110 (e.g., renewed memberships, upgraded memberships, etc.), and membership statistics 112. In some embodiments, one or more of the fields (i.e., the areas of the augmented reality presentation 106 including the metrics) are selectable. Selection of one of the fields allows the user to view additional information regarding that field.

The augmented reality presentation 106 can be based on still images (e.g., digital photographs) and/or video (e.g., digital video or a video feed). With respect to still images, the user can capture a still image of the retail facility. The augmented reality presentation 106 includes the still image. The user can then select one or more objects from the still image to view the information associated with the one or more objects. With respect to video, the user can capture a live or recorded video of the retail facility. In the live video example, the augmented reality presentation updates as the user moves the mobile device 104 with respect to the retail facility. The user can select objects from the augmented reality presentation 106 as he or she moves the mobile device 104 with respect to the retail facility to view information associated with the objects.

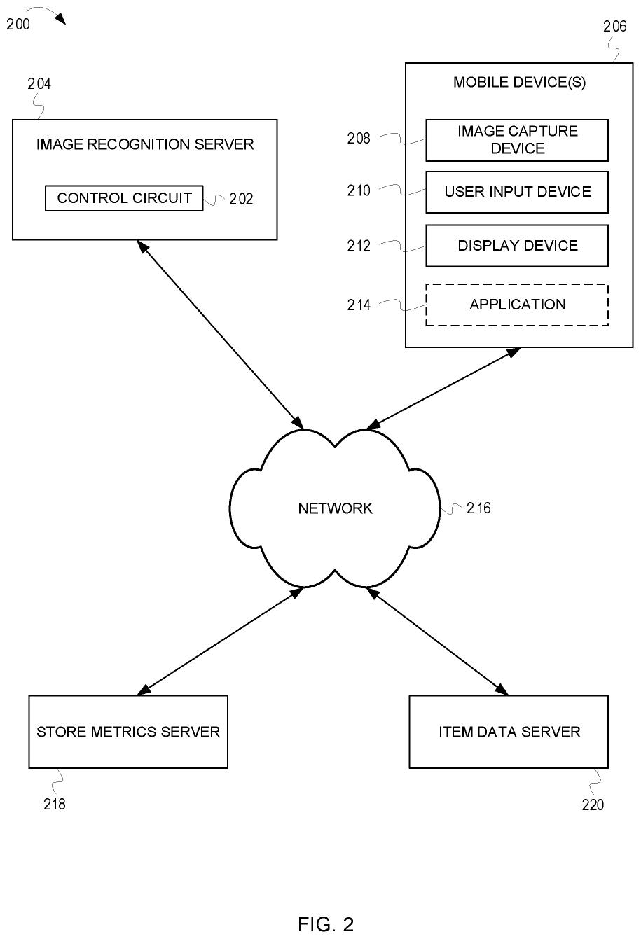

While the discussion of FIGS. 1A and 1B provides an overview of augmented reality presentations for a retail facility, the discussion of FIG. 2 provides additional detail regarding a system for augmented reality presentations.

FIG. 2 is a block diagram of a system 200 for augmented reality presentations, according to some embodiments. The system 200 includes an image recognition server 204, a mobile device(s) 206, a network 216, a store metrics server 218, and an item data server 220. One or more of the image recognition server 204, the mobile device 206, the store metrics server 218, and the item data server 220 are communicatively coupled via the network 216. The network 216 can take any suitable form and include a local area network (LAN) and/or wide area network (WAN), such as the Internet. Accordingly, the network 216 can include wired and/or wireless links.

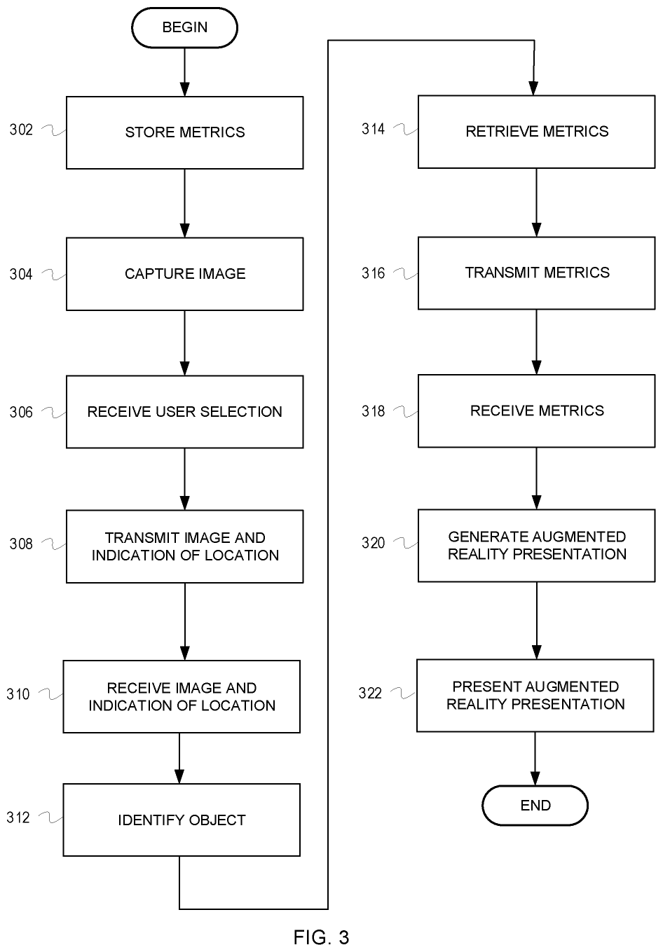

The mobile device 206 can be of any suitable type and include any desired number of mobile devices 206. For example, the mobile device 206 can be a smart phone, a tablet computer, a personal digital assistant (PDA), smart watch, etc. The mobile device 206 generally includes an image capture device 208, a user input device 210, a display device 212, and an application 214. The image capture device 208 is configured to captures images, for example, of a retail facility and/or portions of a retail facility. Accordingly, the mobile device 206 (i.e., the image capture device 208) can include sensors to capture images, such as photo sensors, light sensors, depth sensors, etc. The image capture device 208 can be of any suitable type, and include components such as sensors, lens, apertures, etc. The display device 212 is configured to present augmented reality presentations to the user. Accordingly, the display device 212 can be of any suitable type, such as a light emitting diode (LED) display device, a liquid crystal display (LCD) display device, etc. The user input device 210 is configured to receive user input to, for example, launching the application 214, selecting objects from the augmented reality presentation, etc. Accordingly, the user input device can take any suitable form, such as a keypad, a trackpad, a joystick, a mouse, etc. In some embodiments, the display device 212 and the user input device 210 are integrated into a single device, such as a touchscreen. The application 214 (i.e., an instance of the application 214) is stored on the mobile device 206, for example, in a memory device. The application 214 can be executed by the mobile device 206 in concert with other software modules or applications (i.e., computer program code), or groups of applications, such as operating systems, locationing applications (e.g., mapping, GPS, etc. applications), two-factor authentication applications (TFA), single sign on (SSO) applications, graphics processing applications, security applications, etc. In one embodiment, the application 214 is an augmented reality application, as described herein. In such embodiments, the application 214 can be a dedicated application (e.g., an application specific to a retailer or to augmented reality presentations) or a general purpose application that, while not a “dedicated application,” can perform the functions described herein with respect to augmented reality presentations. In some embodiments, the application 214 is an add-on application installed on the mobile device 206 and that cooperates with other application(s) of the mobile device 206, such as the operating system and works with other application(s) to provide the functionality described herein. For example, in the embodiment illustrated in FIG. 2, the application 214 communicates with the operating system of the mobile device 206 to control and receive data from at least the display device 212, the user input device 210, and the image capture device 208. The application 214 is configured to be executed by the mobile device 206. The application, when executed by the mobile device 206, causes the mobile device 206 to perform actions associated with the presentation of the augmented reality presentation, as discussed in more detail with respect to FIG. 3.

The image recognition server 204 generally identifies objects in the images (e.g., images of the retail facility captured by the mobile device 206) and segments the images based on the objects. It should be noted, however, that in some embodiments the actions described herein with respect to the image recognition server 204 can be performed by the mobile device 206. That is, in some embodiments, the mobile device 206 can identify the objects in the images and segment the images based on the products.

In some embodiments, the image recognition server 204 includes a control circuit 202. The control circuit 202 can comprise a fixed-purpose hard-wired hardware platform (including but not limited to an application-specific integrated circuit (ASIC) (which is an integrated circuit that is customized by design for a particular use, rather than intended for general-purpose use), a field-programmable gate array (FPGA), and the like) or can comprise a partially or wholly-programmable hardware platform (including but not limited to microcontrollers, microprocessors, and the like). These architectural options for such structures are well known and understood in the art and require no further description here. The control circuit 202 is configured (for example, by using corresponding programming as will be well understood by those skilled in the art) to carry out one or more of the steps, actions, and/or functions described herein.

By one optional approach the control circuit 202 operably couples to a memory. The memory may be integral to the control circuit 202 or can be physically discrete (in whole or in part) from the control circuit 202 as desired. This memory can also be local with respect to the control circuit 202 (where, for example, both share a common circuit board, chassis, power supply, and/or housing) or can be partially or wholly remote with respect to the control circuit 202 (where, for example, the memory is physically located in another facility, metropolitan area, or even country as compared to the control circuit 202).

This memory can serve, for example, to non-transitorily store the computer instructions that, when executed by the control circuit 202, cause the control circuit 202 to behave as described herein. As used herein, this reference to “non-transitorily” will be understood to refer to a non-ephemeral state for the stored contents (and hence excludes when the stored contents merely constitute signals or waves) rather than volatility of the storage media itself and hence includes both non-volatile memory (such as read-only memory (ROM) as well as volatile memory (such as an erasable programmable read-only memory (EPROM).

The control circuit 202 performs various tasks with respect to the processing of the images. For example, the control circuit 202 can detect objects within the images, determine boundaries for the objects within the images, segment the image based on the determined boundaries, and associate the sections with the objects included in each of the sections. In one embodiment, the control circuit 202 detects the objects within the images via image recognition. The image recognition can be based on stored images of objects and/or a machine learning model trained with training images. Additionally, or alternatively, the control circuit 202 can detect the objects based on identifiers included in the image, such as text, computer readable identifiers (e.g., barcodes), etc. In such embodiments, the control circuit 202 can read the identifiers via, for example, optical character recognition, pattern recognition, etc.

After detecting the objects in the image, the control circuit 202 determines boundaries for each of the objects. The control circuit 202 can determine the boundaries of the objects in any suitable manner. As one example, the control circuit 202 can identify the object as it is detected. For example, if detected based on image recognition or a read of an identifier, the control circuit 202 can identify the objects. The control circuit 202 can then use the identifications of the objects to retrieve information associated with the objects. For example, the control circuit 202 can retrieve the information associated with the objects from the store metrics server 218. In such embodiments, the store metrics server 218 stores information associated with the objects. Additionally, in some embodiments, the control circuit 202 can retrieve information about products from an item data server 220. In such embodiments, the item data server 220 store product data. The product data can include images of the products, prices for the products, inventory information for the products, dimensions for the products, etc. The control circuit 202 can determine the boundaries for the objects based on dimensions for the objects and the locations of the objects in the image. As another example, the control circuit 202 can determine the boundaries for the objects based on the recognized objects. For example, because the control circuit 202 knows what the objects are, the control circuit 202 knows what the objects looks like and where the objects end (i.e., the boundaries of the objects). That is, the control circuit 202 has recognized the object via image recognition and thus can determine the boundaries of the objects based on the recognized object in the image. As another example, the control circuit 202 may be able to determine the boundaries without identifying the objects in the image. For example, gaps (e.g., dark or light spaces) may exist between the objects and the gaps may signify the object boundaries, or a variation in colors between adjacent objects may indicate the boundaries of the objects.

The control circuit 202 next segments the images into sections. The control circuit 202 segments the images based on the boundaries such that one object is in each section. The control circuit 202 associates each of the objects in included in the images with one of the sections. In this manner, when a user selects an object (i.e., a location in the image), the object that has been selected can be determined (i.e., based on the location in the image that the customer selected). In one embodiment, the control circuit 202 transmits an indication of the associations between the objects and the sections to one or more of the mobile devices 206.

While the discussion of FIG. 2 provides additional detail regarding a system for augmented reality presentations, the discussion of FIG. 3 provides additional detail regarding operations of such a system.

FIG. 3 is a flow chart depicting example operations for presenting an augmented reality presentation. The flow begins at block 302.

At block 302, metrics are stored. For example, a database, such as a store metrics server, can store metrics for a retail facility. The metrics are associated with departments of the retail facility. The metrics can be of any suitable type, such as memberships sold, memberships renewed, trends, memberships expiring soon, types of memberships purchased, a number of memberships upgraded, membership conversion rates, total sales (e.g., for a department), sales metrics, retail facility sales data, etc. The flow continues at block 304.

At block 304, an image is captured. For example, a mobile device can capture an image. In some embodiments, an application executing on the mobile device causes the mobile device to capture the image. The image is of a retail facility (e.g., a portion of a retail facility). The image can include any portion of the retail facility, such as an exterior of a retail facility (e.g., a parking lot, a loading dock, a receiving area, etc.) and an interior of a retail facility (e.g., a stockroom, a sales floor, an employee area, etc.). The image includes objects. At least some of the objects in the image are associated with departments. For example, the objects can include signs, device (e.g., POS terminals), carts, product display units, storage racks, etc. The flow continues at block 306.

At block 306, a user selection is received. For example, the mobile device can receive the user selection via a user input device. In some embodiments, the application executing on the mobile device receives the user selection. The user selection is associated with a location on the image and selects one of the objects in the image. The flow continues at block 308.

At block 308, the image and an indication of the location on the image is transmitted. For example, the mobile device can transmit the image and the indication of the location on the image. In one embodiment, the application executing on the mobile device causes the mobile device to transmit the image and the indication of the location on the image. The flow continues at block 310.

At block 310, the image and the indication of the location on the image is received. For example, a control circuit can receive the image and the indication of the location on the image. The flow continues at block 312.

At block 312, the object is identified. For example, the control circuit can identify the object. The control circuit identifies the object based on the image and indication of the location on the image. The object is the object that was selected by the user based on the user input. The control circuit can identify the object based on any suitable technique. As one example, the control circuit can identify the object based on a machine learning algorithm (e.g., image recognition). As another example, the control circuit can identify the object based on human- and/or machine-readable codes on the object and/or in the image. The object is associated with one of the departments. Accordingly, identification of the object likewise identifies the department selected by the user. The flow continues at block 314.

At block 314, metrics are retrieved. For example, the control circuit can retrieve the metrics from the database. The control circuit retrieves the metrics for the department associated with the object selected by the user. The flow continues at block 316.

At block 316, the metrics are transmitted. For example, the control circuit can transmit the metrics. The control circuit transmits the metrics to the mobile device. The flow continues at block 318.

At block 318, the metrics are received. For example, the mobile device can receive the metrics. The mobile device receives the metrics from the control circuit. The flow continues at block 320.

At block 320, an augmented reality presentation is generated. For example, the mobile device can generate the augmented reality presentation. In some embodiments, the application executing on the mobile device generates the augmented reality presentation. The augmented reality presentation includes the image and a presentation of the metrics associated with the department. As previously discussed, the augmented reality presentation can be based on a still image and/or a video. In some embodiments, the user can select objects from the augmented reality presentation. For example, the user may be able to select any of the metrics or fields associated with the metrics to view additional information. In such embodiments, a user selection may transmit data to the control circuit to retrieve further information from the database. As another example, the user selection may select another object from within the image. Such a selection may cause the steps to begin again at block 308, in which metrics for the newly selected department are retrieved. The flow continues at block 322.

At block 322, the augmented reality presentation is presented. For example, the mobile device can present the augmented reality presentation via the display device. In some embodiments, the application executing on the mobile device causes the mobile device to present the augmented reality presentation.

While the discussion of FIG. 3 provides additional detail regarding operations for a system for augmented reality presentations, the discussion of FIG. provides additional detail regarding mobile devices.

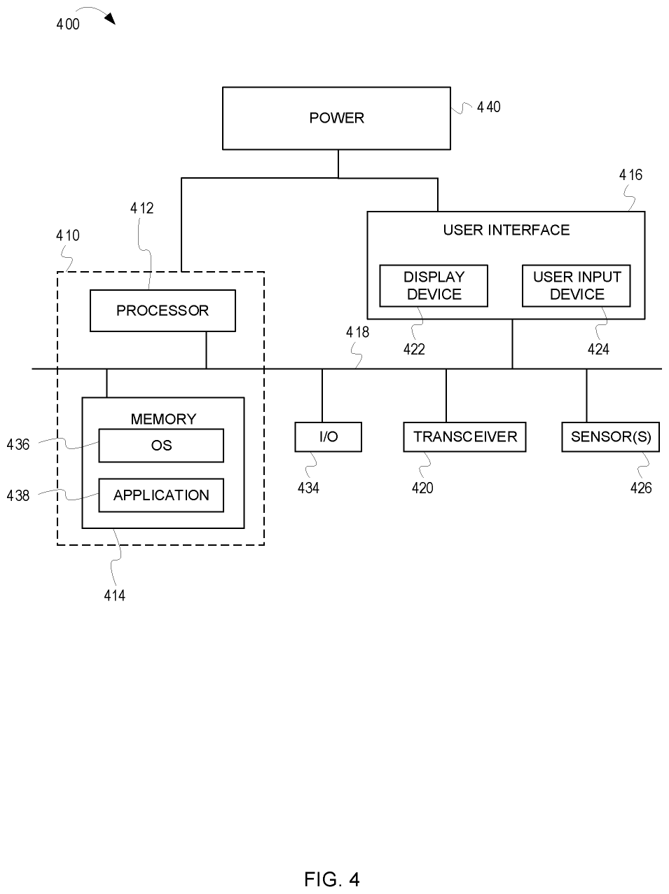

FIG. 4 is a block diagram of a mobile device 400, according to some embodiments. The mobile device 400 may be used for implementing any of the components, systems, functionality, apparatuses, processes, or devices of the system 200 of FIG. 2, and/or other above or below mentioned systems or devices, or parts of such functionality, systems, apparatuses, processes, or devices. The systems, devices, processes, methods, techniques, functionality, services, servers, sources and the like described herein may be utilized, implemented and/or run on many different types of devices and/or systems.

By way of example, the mobile device 400 may comprise a control circuit or processor 412, memory 414, and one or more communication links, paths, buses or the like 418. Some embodiments may include one or more user interfaces 416, and/or one or more internal and/or external power sources or supplies 440. The control circuit can be implemented through one or more processors, microprocessors, central processing unit, logic, local digital storage, firmware, software, and/or other control hardware and/or software, and may be used to execute or assist in executing the steps of the processes, methods, functionality and techniques described herein, and control various communications, decisions, programs, content, listings, services, interfaces, logging, reporting, etc. Further, in some embodiments, the processor 412 can be part of control circuitry and/or a control system 410, which may be implemented through one or more processors with access to one or more memory 414 that can store commands, instructions, code and the like that is implemented by the control circuit and/or processors to implement intended functionality. In some applications, the control circuit and/or memory may be distributed over a communications network (e.g., LAN, WAN, Internet) providing distributed and/or redundant processing and functionality. Again, the mobile device 400 may be used to implement one or more of the above or below, or parts of, components, circuits, systems, processes and the like.

In one embodiment, the memory 414 stores data and executable code, such as an operating system 436 and an application 438. The application 438 is configured to be executed by the mobile device 400 (e.g., by the processor 412). The application 438 can be a dedicated application (e.g., an application dedicated to augmented reality presentations) and/or a general purpose application (e.g., a web browser, a retail application etc.). Additionally, though only a single instance of the application 438 is depicted in FIG. 4, such is not required and the single instance of the application 438 is shown in an effort not to obfuscate the figures. Accordingly, the application 438 is representative of all types of applications resident on the mobile device (e.g., software preinstalled by the manufacturer of the mobile device, software installed by an end user, etc.). In one embodiment, the application 438 operates in concert with the operating system 436 when executed by the processor 412 to cause actions to be performed by the mobile device 400. For example, with respect to the disclosure contained herein, execution of the application 438 by the processor 412 causes the mobile device to perform actions consistent with the presentation of augmented reality presentations as described herein.

The user interface 416 allows a user to interact with the mobile device 400 and receive information through the system. In some instances, the user interface 416 includes a display device 422 and/or one or more user input device 424, such as buttons, touch screen, track ball, keyboard, mouse, etc., which can be part of or wired or wirelessly coupled with the mobile device 400. Typically, the mobile device 400 further includes one or more communication interfaces, ports, transceivers 420 and the like allowing the mobile device 400 to communicate over a communication bus, a distributed computer and/or communication network (e.g., a local area network (LAN), wide area network (WAN) such as the Internet, etc.), communication link 418, other networks or communication channels with other devices and/or other such communications or combination of two or more of such communication methods. Further the transceiver 420 can be configured for wired, wireless, optical, fiber optical cable, satellite, or other such communication configurations or combinations of two or more of such communications. Some embodiments include one or more input/output (I/O) ports 434 that allow one or more devices to couple with the mobile device 400. The I/O ports can be substantially any relevant port or combinations of ports, such as but not limited to USB, Ethernet, or other such ports. The I/O interface (i.e., I/O ports 434) can be configured to allow wired and/or wireless communication coupling to external components. For example, the I/O interface can provide wired communication and/or wireless communication (e.g., Wi-Fi, Bluetooth, cellular, RF, and/or other such wireless communication), and in some instances may include any known wired and/or wireless interfacing device, circuit and/or connecting device, such as but not limited to one or more transmitters, receivers, transceivers, or combination of two or more of such devices.

In some embodiments, the mobile device 400 may include one or more sensors 426 to provide information to the system and/or sensor information that is communicated to another component, such as the central control system, a delivery vehicle, etc. The sensors 426 can include substantially any relevant sensor, such as distance measurement sensors (e.g., optical units, sound/ultrasound units, etc.), optical-based scanning sensors to sense and read optical patterns (e.g., bar codes), radio frequency identification (RFID) tag reader sensors capable of reading RFID tags in proximity to the sensor, imaging system and/or camera, other such sensors or a combination of two or more of such sensor systems. The foregoing examples are intended to be illustrative and are not intended to convey an exhaustive listing of all possible sensors. Instead, it will be understood that these teachings will accommodate sensing any of a wide variety of circumstances in a given application setting.

The mobile device 400 comprises an example of a control and/or processor-based system with the control circuit. Again, the control circuit can be implemented through one or more processors, controllers, central processing units, logic, software and the like. Further, in some implementations the control circuit may provide multiprocessor functionality.

The memory 414, which can be accessed by the control circuit, typically includes one or more processor-readable and/or computer-readable media accessed by at least the control circuit, and can include volatile and/or nonvolatile media, such as RAM, ROM, EEPROM, flash memory and/or other memory technology. Further, the memory 414 is shown as internal to the control system 410; however, the memory 414 can be internal, external or a combination of internal and external memory. Similarly, some or all of the memory 414 can be internal, external or a combination of internal and external memory of the control circuit. The external memory can be substantially any relevant memory such as, but not limited to, solid-state storage devices (SSDs) or drives, hard disk drives (HDDs), one or more of universal serial bus (USB) stick or drive, flash memory secure digital (SD) card, other memory cards, and other such memory or combinations of two or more of such memory, and some or all of the memory may be distributed at multiple locations over a computer network. The memory 414 can store code, software, executables, scripts, data, content, lists, programming, programs, log or history data, user information, customer information, product information, and the like. While FIG. 4 illustrates the various components being coupled together via a bus, it is understood that the various components may actually be coupled to the control circuit and/or one or more other components directly.

Further, it is noted that while FIG. 4 illustrates a generic architecture of the mobile device 400 in some embodiments, this similar architecture can apply to at least the control circuit 202 of FIG. 2. For example, the control circuit 202 could equate to the processor 412 of FIG. 4, and it is understood that the control circuit 202 would likewise be coupled to or have access to one or more of memories, power, user interfaces, I/Os, transceivers, sensors, etc.

In some embodiments, an augmented reality system for use in a retail facility comprises a database, wherein the database is configured to store metrics associated with departments of the retail facility, an application configured to be executed on a mobile device, wherein execution of the application on the mobile device causes the mobile device to capture, via an image capture device, an image, wherein the image includes a portion of the retail facility and a plurality of objects, receive, via a user input device, a user selection, wherein the user selection is associated with a location on the image, and wherein the user selection selects one of the plurality of objects from the image, and transmit, via a communications network to a control circuit, the image and an indication of the location on the image, the control circuit, wherein the control circuit is communicatively coupled to the mobile device, and wherein the control circuit is configured to receive, from the mobile device, the image and the indication of the location on the image, identify, based on the image and the indication of the location on the image, the one of the plurality of objects, wherein the one of the plurality of objects is associated with a department of the retail facility, retrieve, from the database, metrics for the department of the retail facility, transmit, to the mobile device, the metrics for the department of the retail facility, wherein execution of the application on the mobile device further causes the mobile device to receive, from the control circuit, the metrics for the department of the retail facility, generate, based on the image and the metrics for the department of the retail facility, an augmented reality presentation, wherein the augmented reality presentation includes the image and a presentation of the metrics for the department of the retail facility, and present, via a display device, the augmented reality presentation.

In some embodiments, an apparatus, and a corresponding method performed by the apparatus, comprises storing, in a database, metrics associated with departments of the retail facility, causing capture, by an application executing on a mobile device via an image capture device of the mobile device, of an image, wherein the image includes a portion of the retail facility and a plurality of objects, causing receipt, by the application executing on the mobile device via a user input device of the mobile device, of a user selection, wherein the user selection is associated with a location on the image, and wherein the user selection selects one of the plurality of objects from the image, causing transmission, by the application executing on the mobile device via a communications network to a control circuit, of the image and an indication of the location on the image, receiving, from the mobile device by the control circuit, the image and the indication of the location on the image, identifying, by the control circuit based on the image and the indication of the location on the image, the one of the plurality of objects, wherein the one of the plurality of objects is associated with a department of the retail facility, retrieving, by the control circuit from the database, metrics for the department of the retail facility, transmitting, by the control circuit to the mobile device, the metrics for the department of the retail facility, receiving, by the application executing on the mobile device from the control circuit, the metrics for the department of the retail facility, generating, by the application executing on the mobile device based on the image and the metrics for the department of the retail facility, an augmented reality presentation, wherein the augmented reality presentation includes the image and a presentation of the metrics for the department of the retail facility, and causing presentation, by the application executing on the mobile device via a display device, of the augmented reality presentation.

Those skilled in the art will recognize that a wide variety of other modifications, alterations, and combinations can also be made with respect to the above described embodiments without departing from the scope of the invention, and that such modifications, alterations, and combinations are to be viewed as being within the ambit of the inventive concept.

What is claimed is:

1. An augmented reality system for use in a retail facility, the system comprising:
a database, wherein the database is configured to store metrics associated with departments of the retail facility;
an application configured to be executed on a mobile device, wherein execution of the application on the mobile device causes the mobile device to:
capture, via an image capture device, an image, wherein the image includes a portion of the retail facility and a plurality of objects;
receive, via a user input device, a user selection, wherein the user selection is associated with a location on the image, and wherein the user selection selects one of the plurality of objects from the image; and
transmit, via a communications network to a control circuit, the image and an indication of the location on the image;
the control circuit, wherein the control circuit is communicatively coupled to the mobile device, and wherein the control circuit is configured to:
receive, from the mobile device, the image and the indication of the location on the image;
identify, based on the image and the indication of the location on the image, the one of the plurality of objects, wherein the one of the plurality of objects is associated with a department of the retail facility;
retrieve, from the database, metrics for the department of the retail facility; and
transmit, to the mobile device, the metrics for the department of the retail facility;
wherein execution of the application on the mobile device further causes the mobile device to:
receive, from the control circuit, the metrics for the department of the retail facility;
generate, based on the image and the metrics for the department of the retail facility, an augmented reality presentation, wherein the augmented reality presentation includes the image and a presentation of the metrics for the department of the retail facility; and
present, via a display device, the augmented reality presentation.

2. The augmented reality system of claim 1, wherein the departments of the retail facility include one or more of a member services department, a pharmacy department, point-of-sale (POS) department, an optical department, a grocery department, a sporting goods department, an electronics department, an automotive department, a fueling department, a photo department, and a bakery department.

3. The augmented reality system of claim 1, wherein the metrics associated with departments of the retail facility include one or more of memberships sold, memberships renewed, trends, memberships expiring soon, types of memberships purchased, number of membership upgrades, membership conversion rates, total sales, sales metrics, and retail facility sales data.

4. The augmented reality system of claim 1, wherein the control circuit is further configured to:
detect, based on the image, the plurality of objects;
determine, for the image, boundaries for each of the plurality of objects;
segment, based on the boundaries for each of the plurality of objects, the image into sections, wherein each of the sections is associated with one of the plurality of objects;
wherein the identification of the one of the plurality of objects is based on the indication of the location of the image and the sections.

5. The augmented reality system of claim 4, wherein the control circuit determines the boundaries for each of the plurality of objects based on a machine learning algorithm.

6. The augmented reality system of claim 4, wherein the plurality of objects includes one or more of identification signs, price signs, products, product display units, location identifiers, colors, and text.

7. The augmented reality system of claim 1, wherein the mobile device is one of a smart phone, a tablet, and a dedicated retail device.

8. The augmented reality system of claim 1, wherein the augmented reality presentation includes a marker identifying one or more of the one of the plurality of objects and the department.

9. The augmented reality system of claim 1, wherein the image is part of a video feed captured by the mobile device.

10. The augmented reality system of claim 1, wherein the augmented reality presentation includes one or more selections, wherein selection of each of the one or more selections causes the augmented reality presentation to be updated to include additional information.

11. A method for use in a retail facility, the method comprising:
storing, in a database, metrics associated with departments of the retail facility;
causing capture, by an application executing on a mobile device via an image capture device of the mobile device, of an image, wherein the image includes a portion of the retail facility and a plurality of objects;
causing receipt, by the application executing on the mobile device via a user input device of the mobile device, of a user selection, wherein the user selection is associated with a location on the image, and wherein the user selection selects one of the plurality of objects from the image;
causing transmission, by the application executing on the mobile device via a communications network to a control circuit, of the image and an indication of the location on the image;
receiving, from the mobile device by the control circuit, the image and the indication of the location on the image;
identifying, by the control circuit based on the image and the indication of the location on the image, the one of the plurality of objects, wherein the one of the plurality of objects is associated with a department of the retail facility;
retrieving, by the control circuit from the database, metrics for the department of the retail facility;
transmitting, by the control circuit to the mobile device, the metrics for the department of the retail facility;
receiving, by the application executing on the mobile device from the control circuit, the metrics for the department of the retail facility;
generating, by the application executing on the mobile device based on the image and the metrics for the department of the retail facility, an augmented reality presentation,
wherein the augmented reality presentation includes the image and a presentation of the metrics for the department of the retail facility; and
causing presentation, by the application executing on the mobile device via a display device, of the augmented reality presentation.

12. The method of claim 11, wherein the departments of the retail facility include one or more of a member services department, a pharmacy department, point-of-sale (POS) department, an optical department, a grocery department, a sporting goods department, an electronics department, an automotive department, a fueling department, a photo department, and a bakery department.

13. The method of claim 11, wherein the metrics associated with departments of the retail facility include one or more of memberships sold, memberships renewed, trends, memberships expiring soon, types of memberships purchased, number of membership upgrades, membership conversion rates, total sales, sales metrics, and retail facility sales data.

14. The method of claim 11, further comprising:
detecting, by the control circuit based on the image, the plurality of objects;
determining, by the control circuit for the image, boundaries for each of the plurality of objects;
segmenting, by the control circuit based on the boundaries for each of the plurality of objects, the image into sections, wherein each of the sections is associated with one of the plurality of objects;
wherein the identification of the one of the plurality of objects is based on the indication of the location of the image and the sections.

15. The method of claim 14, wherein the control circuit determines the boundaries for each of the plurality of objects based on a machine learning algorithm.

16. The method of claim 14, wherein the plurality of objects includes one or more of identification signs, price signs, products, product display units, location identifiers, colors, and text.

17. The method of claim 11, wherein the mobile device is one of a smart phone, a tablet, and a dedicated retail device.

18. The method of claim 11, wherein the augmented reality presentation includes a marker identifying one or more of the one of the plurality of objects and the department.

19. The method of claim 11, wherein the image is part of a video feed captured by the mobile device.

20. The method of claim 11, wherein the augmented reality presentation includes one or more selections, wherein selection of each of the one or more selections causes the augmented reality presentation to be updated to include additional information.
